(19) United States
(12) Patent Application Publication
(10) Pub. No.: US 2010/0175073 A1
(43) Pub. Date: Jul. 8, 2010

(54) NETWORK DEVICE FOR ACCELERATING ISCSI PACKET PROCESSING

(75) Inventors: Zhi-Jiang Hu, Tianjin (CN); Qian Zhang, Tianjin (CN); Tom Chen, Taipei (TW)

Correspondence Address: STEVENS & SHOWALTER LLP, 7019 CORPORATE WAY, DAYTON, OH, 45459-4238, US

(73) Assignee: INVENTEC CORPORATION, Taipei (TW)

(21) Appl. No.: 12/349,561

(22) Filed: Jan. 7, 2009

(51) Int. Cl. G06F 9/46

(52) U.S. Cl. 719/326

(57) ABSTRACT

A network device for accelerating internet small computer systems interface (iSCSI) packet processing is described, which includes a host and a network card. The host includes an online command descriptor block queue, an iSCSI host manager, and an SCSI module. SCSI commands in a CDB are processed through these modules. The network card includes an LLP module and a microprocessor. Through a protocol data unit descriptor, a PDU generator and an iSCSI network card manager in the microprocessor, protocol data units in network packets can be resolved in advance, so that the host can concentrate on executing SCSI commands, thereby accelerating the network packet processing efficiency of the network device.

### BACKGROUND OF THE INVENTION

1. Field of the Invention

The present invention relates to a network device, and more particularly, to a network device for accelerating iSCSI packet processing.

2. Related Art

With the rapid progress of the network storage technology, network storage has become more and more popular. A communication protocol standard called internet small computer systems interface (iSCSI) has been proposed by IETF. The iSCSI technology, as a protocol for realizing network storage, enables storage spaces of a plurality of computer hosts to be connected in series based upon a TCP/IP communication protocol, so as to form a virtual network disk (also called “iSCSI network disk”). The iSCSI network disk is characterized in an easy installation, low cost, expansion/backup capability for infinitely expanding a capacity of a virtual storage device, which has been gradually favored by many enterprises.

The iSCSI is based upon the TCP/IP communication protocol, in which an upper layer thereof is a small computer systems interface (SCSI) protocol, and a lower layer thereof is TCP/IP and a low layer protocol (LLP). FIG. 1A is a schematic view of a conventional system architecture. Referring to FIG. 1A, one party for initiating the communication is called an initiator, and the other linked party is called a target. Both the initiator and the target adopt the same system architecture that includes an SCSI 110a, an iSCSI 120a, a host stack 130a, and a network card hardware 140a. When an application in the initiator sends a data read/write request, the SCSI 110a of the initiator generates a corresponding SCSI command, encapsulates the corresponding SCSI command into a command descriptor block (CDB) through the iSCSI 120a based upon message semantic, encapsulates the CDB into a protocol data unit (PDU), and then transmits the PDU to the target through the TCP/IP communication protocol. Upon receiving the PDU, the target also resolves the content of the SCSI command layer by layer, thereby triggering the device thereof to execute the SCSI command. After the SCSI command has already been executed, the target sends a command response back to the initiator through a flow similar to the above process of encapsulating the SCSI command into the PDU packet layer by layer. In recent years, the transmission speed of the network card device is greatly enhanced, which is increased from the original 10 Mbps to the current high-speed transmission of 10 Gbps. The enhancement of the transmission speed of a hardware device brings about a corresponding enhancement of an access speed of the network storage device. However, the data processing capacity of the network storage device becomes a bottleneck for the performance of the network storage device. FIG. 1B is a schematic view of a conventional system architecture having a TCP offload engine (TOE) function. Referring to FIG. 1B, when a network card hardware 140b receives a packet, a firmware stack 130b with the TOE function retrieves the TCP payload from the packet and transmits the TCP payload to an SCSI 110b and an iSCSI 120b at the upper layer for being processed. However, although the TOE technology can accelerate the process of resolving the content of the TCP packet through the network card hardware, the iSCSI protocol still need be processed by the host. It is still a heavy working pressure for the host to process and verify a great deal of PDUs, which may even cause a bottleneck of the performance of the whole network storage device.

### SUMMARY OF THE INVENTION

In view of the above problem about the bottleneck of the performance of the network storage device, the present invention is directed to a network device for accelerating iSCSI packet processing, in which a microprocessor is added to a network card to enable the network card to has a hardware TOE function, and headers and data of PDUs are processed through the network card, so that the host can concentrate on executing SCSI commands without consuming additional computation resources for analyzing PDUs, thereby accelerating a packet processing speed of the whole network storage device.

In order to achieve the aforementioned object, the present invention provides a network device for accelerating iSCSI packet processing, which includes a host and a network card. The host includes an online command descriptor block queue, an iSCSI host manager, and an SCSI module. The online command descriptor block queue is used to store received SCSI commands in queues. The iSCSI host manager receives an SCSI command, and returns a corresponding response packet. The SCSI module is used to execute the SCSI command. The network card includes a low-layer protocol processing module (LLP module) and a microprocessor. The LLP module is used to receive or transmit a network packet. The microprocessor is used to monitor a network packet received by the LLP module. The microprocessor further includes a PDU descriptor, a PDU generator, and an iSCSI network card manager. The PDU descriptor resolves an input PDU in the received network packet into a first file header and a data segment. The PDU generator adds a second file header into the response packet to generate an output PDU, and delivers the output PDU to the LLP module. The iSCSI network card manager reads the CDB of the first file header, so as to determine a task of the CDB, and notify the iSCSI host manager to execute the task.

In the network device for accelerating iSCSI packet processing according to a preferred embodiment of the present invention, the network card further includes a set of memories for storing input PDUs and output PDUs, and a direct memory access module, for directly accessing an input data buffer and an output data buffer. The direct memory access module can also directly access the memory in the network card. The iSCSI network card manager may trigger the direct memory access module according to the first file header, so as to directly write data into the input data buffer. The iSCSI host manager may directly trigger the direct memory access module to directly retrieve an SCSI command data from the output data buffer, and directly store the SCSI command data into the memory of the network card.

In the network device for accelerating iSCSI packet processing according to a preferred embodiment of the present invention, the microprocessor processes a network packet received from the LLP module or transmits a packet data to the LLP module through a multi-thread technology.

Based upon the above, in the network device for accelerating iSCSI packet processing of the present invention, a microprocessor is set in the network card, and network packets are processed by modules such as an iSCSI network card manager, a PDU descriptor, and a PDU generator, so as to retrieve a PDU in the packet in advance and resolve an SCSI command data carried in the PDU. Once the SCSI command data is obtained, the SCSI command data is delivered to the iSCSI host manager and the SCSI module of the host for executing the iSCSI/SCSI command subsequently. Since the host only concentrates on executing the iSCSI/SCSI command, without performing trivial operations of monitoring packets and resolving, the iSCSI packet processing speed of the network device can be enhanced.

### BRIEF DESCRIPTION OF THE DRAWINGS

The present invention will become more fully understood from the detailed description given herein below for illustration only, which thus is not limitative of the present invention, and wherein:

FIG. 1A is a schematic view of a conventional system architecture;

FIG. 1B is a schematic view of a conventional system architecture having a TOE function;

FIG. 2 is a schematic view of a system architecture according to a preferred embodiment of the present invention; and

FIG. 3 is a schematic view of a detailed system architecture according to a preferred embodiment of the present invention.

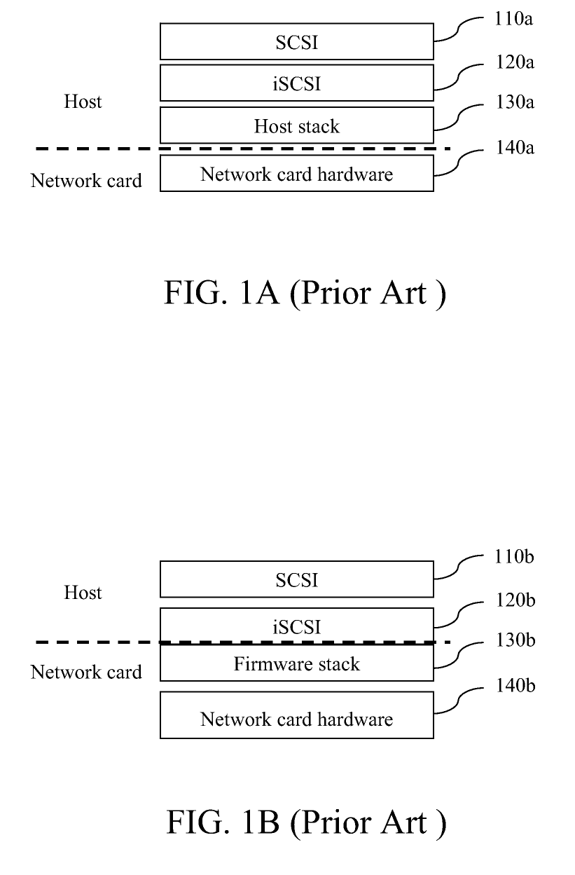

### DETAILED DESCRIPTION OF THE INVENTION

The objective and implementation method of the present invention are described in detail through the following preferred embodiments. However, the concept of the present invention can also be applied in other scopes. The following embodiments are merely intended to illustrate the objective and implementation method of the present invention, but not to limit the scope of the present invention.

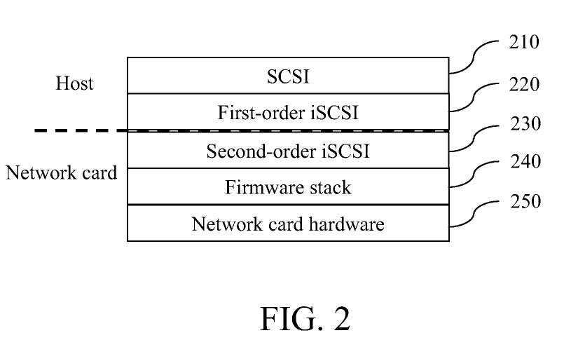

FIG. 2 is a schematic view of a system architecture according to a preferred embodiment of the present invention. Referring to FIG. 2, in this embodiment, a network device for accelerating iSCSI packet processing includes a host and a network card. The host includes an SCSI 210 and a first-order iSCSI 220. The network card includes a second-order iSCSI 230, a firmware stack 240, and a network card hardware 250. The SCSI 210, the firmware stack 240, and the network card hardware 250 are similar to that of the system architecture of the conventional iSCSI network device, but different from that of the conventional network device. In this embodiment, the iSCSI is divided into two parts, i.e., the first-order iSCSI 220 is used for executing iSCSI commands, i.e., concentrating on executing the iSCSI commands carried in a PDU, and the second-order iSCSI 230 is responsible for the other trivial operations that consume a lot of computation resources, such as TCP/IP downloading of network packets (i.e., distinguishing TCP headers and contents) and resolving the header and data of the PDU. In other words, in this embodiment, the task of resolving the formats of network packets is achieved by the network card hardware, and the host does not occupy additional computation resources to monitor packets, resolve PDUs, or retrieve the SCSI Command. While the host is processing iSCSI/SCSI commands, the network card also resolves or encapsulates network packets, thereby significantly enhancing the iSCSI packets processing efficiency of the network device.

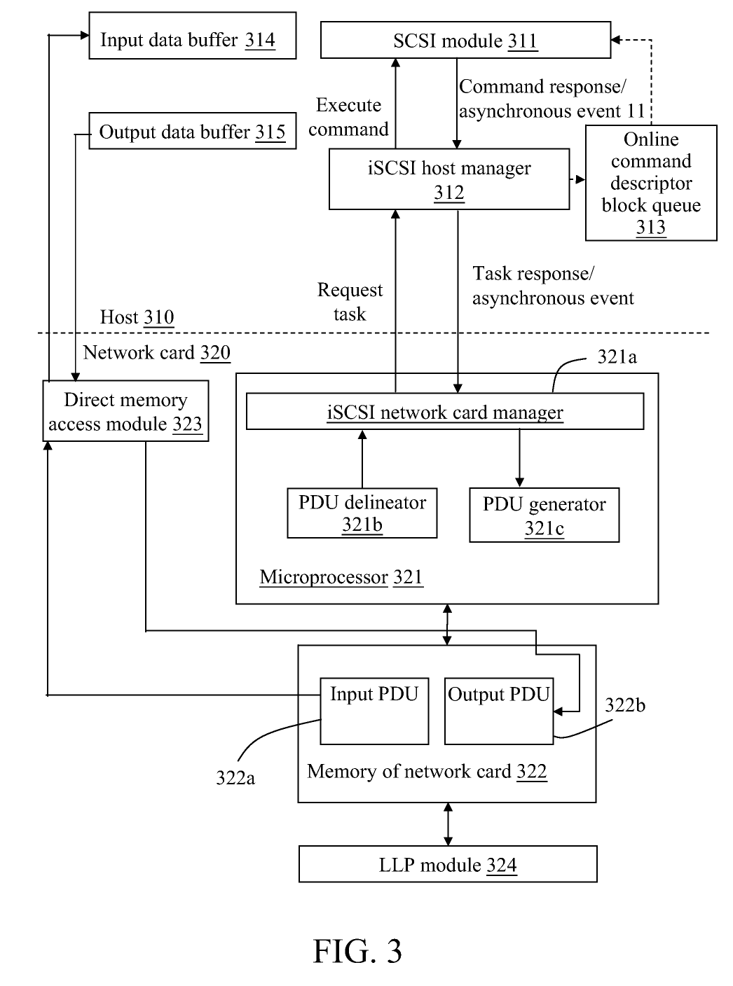

Furthermore, the system architecture of the present invention is further described in detail through another embodiment. FIG. 3 is a schematic view of a detailed system architecture according to a preferred embodiment of the present invention. Referring to FIG. 3, a network device for accelerating iSCSI packet processing includes a host 310 and a network card 320. In this embodiment, the host 310 includes an SCSI module 311, an iSCSI host manager 312, and an online command descriptor block queue 313. The SCSI module 311 is used to execute an SCSI command. The iSCSI host manager 312 is used to receive an SCSI command or execute an iSCSI command, and returns a response packet corresponding to the iSCSI/SCSI command after the execution of the iSCSI/SCSI command. The online command descriptor block queue 313 is used to store all the received SCSI commands in queues and deliver the SCSI commands to the SCSI module 311 according to an order of commands, or temporarily store the unprocessed SCSI commands, thereby avoiding system delay or system error caused by the SCSI commands that are not processed in time due to too heavy network traffic. The network card 320, as a network card with a computation capacity, includes a low-layer protocol processing module (LLP module) 324, for receiving or transmitting network packets, and a microprocessor 321, for monitoring network packets received by the LLP module 324. The microprocessor includes a PDU delineator 321b, a PDU generator 321c, and an iSCSI network card manager 321a. The PDU delineator 321b is used for resolving an input PDU 322a from the received network packet into a first file header and a data segment. The PDU generator 321c is used to add a second file header to the response packet of the host 310 to generate an output PDU 322b, and deliver the output PDU 322b to the LLP module 324 for being transmitted based upon the TCP/IP. The iSCSI network card manager 321a is used to read the CDB of the first file header, so as to determine a task in the CDB, and notify the iSCSI host manager 312 to perform the task. The network device for accelerating iSCSI packet processing operates in the following manner. The microprocessor 321 of the network card 320 monitors a network packet, and resolves the input PDU 322a according to a data format specified by the iSCSI protocol and stores the input PDU 322a in the memory 322 of the network card. Meanwhile, the microprocessor 321 further resolves the header of the input PDU 322a. If the header of the input PDU 322a represents an SCSI command, information such as CDB and logic unit number (LUN) are retrieved, and it is determined whether to enable the direct memory access module 323 of the network card 320 or not according to the content of the CDB data, so as to directly store the CDB data in the input data buffer 314 of the host 310. Subsequently, the iSCSI network card manager 321a generates a data structure according to the CDB type, which is called a task herein. The iSCSI network card manager 321a notifies the task to the iSCSI host manager 312 of the host 310. All tasks are added to the online command descriptor block queue 313 in sequence, and then delivered to the SCSI module 311 in sequence for being executed. When one task has been executed, the iSCSI host manager 312 returns a reply of the task. Firstly, the iSCSI host manager 312 generates a reply data and returns the reply data to the network card 320. At this time, the data structure is stored in the output data buffer 315, and the iSCSI host manager 312 sends a notification (i.e., sending a task index, and an address and a data length of the reply data) to the iSCSI network card manager 321a. After receiving the notification, the iSCSI network card manager 321a obtains the replied task according to a task ID, gets the reply data of the task from the output data buffer 315, and adds a file header to the reply data of the task to generate the output PDU 322b through the PDU generator 321c, so as to deliver the output PDU 322b to the LLP module, thereby finishing the iSCSI reply motion.

What is claimed is:

1. A network device for accelerating internet small computer systems interface (iSCSI) packet processing, comprising:
a host, comprising:
an online command descriptor block queue, for storing a plurality of received SCSI commands in queues;
an iSCSI host manager, for receiving an SCSI command, and returning a corresponding response packet; and
a SCSI module, for executing an SCSI command; and
a network card, comprising:
a low-layer protocol processing module (LLP module), for receiving or transmitting a network packet; and
a microprocessor, for monitoring the network packet received by the LLP module, wherein the microprocessor further comprises:
a PDU delineator, for resolving an input protocol data unit (PDU) from the received network packet into a first file header and a data segment;
a PDU generator, for adding a second file header to the response packet to generate an output PDU and deliver the output PDU to the LLP module; and
an iSCSI network card manager, for reading a command descriptor block (CDB) of the first file header, so as to determine a task of the CDB and notify the iSCSI host manager to execute the task.

2. The network device for accelerating iSCSI packet processing according to claim 1, wherein the network card further comprises a memory, for storing the input PDU and the output PDU.

3. The network device for accelerating iSCSI packet processing according to claim 1, wherein the host further comprises an input data buffer, for storing SCSI command data of the input PDU.

4. The network device for accelerating iSCSI packet processing according to claim 1, wherein the host further comprises an output data buffer, for storing SCSI command data of the output PDU.

5. The network device for accelerating iSCSI packet processing according to claim 1, wherein the network card further comprises a direct memory access module, for directly accessing the input data buffer and the output data buffer.

6. The network device for accelerating iSCSI packet processing according to claim 5, wherein the direct memory access module is also used to directly access the memory of the network card.

7. The network device for accelerating iSCSI packet processing according to claim 5, wherein the iSCSI network card manager triggers the direct memory access module according to the first file header, so as to directly write data into the input data buffer.

8. The network device for accelerating iSCSI packet processing according to claim 5, wherein the iSCSI host manager triggers the direct memory access module to directly retrieve SCSI command data from the output data buffer and directly store the retrieved SCSI command data into the memory of the network card, or directly send the retrieved SCSI command data to a physical layer of the network card without storing the SCSI command data to the memory of the network card.

9. The network device for accelerating iSCSI packet processing according to claim 1, wherein the microprocessor further processes a network packet received from the LLP module or transmits a packet data to the LLP module through a multi-thread technology.
